(19) United States
(12) Patent Application Publication
(10) Pub. No.: US 2009/0080860 A1
(43) Pub. Date: Mar. 26, 2009

(54) MOVING IMAGE REPRODUCING APPARATUS AND MOVING IMAGE REPRODUCING METHOD

(75) Inventor: Shinichiro Nakano, Kunitachi-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/210,914

(22) Filed: Sep. 15, 2008

(30) Foreign Application Priority Data
Sep. 26, 2007 (JP) 2007-250168

(51) Int. Cl. H04N 7/00; H04N 7/26

(52) U.S. Cl. 386/95; 386/124

(57) ABSTRACT

This digital television broadcast receiving apparatus includes a tab browser function to switch screens by a tab #1 13, a tab #2 14 and reproduce a VOD moving image distributed from a network or an IP broadcast program. A control unit 261 includes a tab screen control unit 261h which switches a screen 11 of a tab #1 13 to inactive and a screen 21 of a tab #2 14 to active when the other tab #2 14 is clicked while the screen 11 of the tab #1 13 is active.

### CROSS-REFERENCE TO RELATED APPLICATION

This application is based upon and claims the benefit of priority from the prior Japanese Patent Application No. 2007-250168, filed on Sep. 26, 2007; the entire contents of which are incorporated herein by reference.

### BACKGROUND

1. Field of the Invention

The present invention relates to, for example, a moving image reproducing apparatus and a moving image reproducing method.

2. Description of the Related Art

Currently, while FTTH is becoming the mainstream for the Internet, moving image distribution services with high image quality, such as video on demand (VOD) for example, are already started for terminals such as computers.

This influence has reached the digital broadcasting industries, and a service such as re-transmission of a television broadcast using IP networks is going to be started shortly.

Further, recently there are also emerging digital television compatible receivers having, not only an Internet connecting function using a communication module for interactive communication services of terrestrial digital broadcasting, but a web browser for browsing content on the Internet.

Due to the flow as such, it is expected that targets of high-quality video distribution using IP networks shift gradually from computers to digital television corresponding receivers hereafter.

With respect to viewing of various video contents distributed from the Internet with a digital television corresponding receiver, a demand to view plural contents by switching the screen may increase.

As a conventional art for switching contents, there already exists a technology for a digital broadcast receiver in which a browser control unit instructs to hold the condition when a channel switch signal is inputted during broadcasting of data broadcast content for example, and instructs to cancel the holding of the condition and instructs to activate a layout drawing unit when it is returned to the original channel (refer to, for example, JP-A 2002-73838 (KOKAI)).

### SUMMARY

with a high performance hardware such as a computer, it is possible to start a plurality of highly functional moving image reproducing applications simultaneously and display a plurality of screens so as to reproduce moving images.

However, in a current situation of the digital television corresponding receivers which are already commercialized as a kind of electric appliance, there is a problem such that it is still difficult in terms of specification to simultaneously start a plurality of moving image reproducing applications, which consume a large amount of resources, so as to display a plurality of screens.

The present invention is made in view of solving such problems, and an object thereof is to provide a moving image content reproducing apparatus and a moving image content reproducing method capable of switching and viewing a plurality of moving image contents by adding a function that consumes as few resources as possible.

A moving image reproducing apparatus according to one aspect of the present invention includes a plurality of moving image reproducing units reproducing a moving image when activated and stopping reproduction of a moving image when inactivated, a storage unit capable of storing information of a position when reproduction of the moving image is stopped for each of the moving image reproducing units, a switching control unit activating, when an operation to activate any one of the plurality of moving image reproducing units is performed, a corresponding one of the moving image reproducing units and switching the other moving image reproducing units to inactive, a storage control unit storing in the storage unit, information of a position where the moving image reproducing unit switched by the switching control unit from active to inactive, stopped reproduction of a moving image, and a reproduction control unit restarting, when an operation of reactivation is performed on one of the moving image reproducing units that is inactivated once, reproduction of the moving image according to information of the stop position read from the storage unit.

A moving image reproducing method according to one aspect of the present invention is a method for a moving image reproducing apparatus including a plurality of moving image reproducing units reproducing a moving image when activated and stopping reproduction of a moving image when inactivated, and the method has a step of activating, when an operation to activate any one of the plurality of moving image reproducing units is performed, a corresponding one of the moving image reproducing units and switching the other moving image reproducing units to inactive, a step of storing in a storage unit information of a position where the moving image reproducing unit switched from active to inactive stopped reproduction of a moving image, and a step of restarting, when an operation of reactivation is performed on one of the moving image reproducing units that is inactivated once, reproduction of the moving image according to information of the stop position read from the storage unit.

Accordingly, a plurality of moving image contents can be switched and viewed by adding a function that consumes as few resources as possible.

### BRIEF DESCRIPTION OF THE DRAWINGS

FIG. 1 is a diagram for explaining an appearance of a digital television broadcast receiving apparatus and a network system structured with this digital television broadcast receiving apparatus being the center.

FIG. 2 is a diagram showing a main signal processing system of the digital television broadcast receiving apparatus.

FIG. 3 shows an example of a tab management table.

FIG. 4 is a diagram for explaining an operation of the digital television broadcast receiving apparatus.

FIG. 5 is a diagram for explaining an operation of the digital television broadcast receiving apparatus.

### DETAILED DESCRIPTION

Hereinafter, embodiments of the present invention will be explained with reference to the drawings.

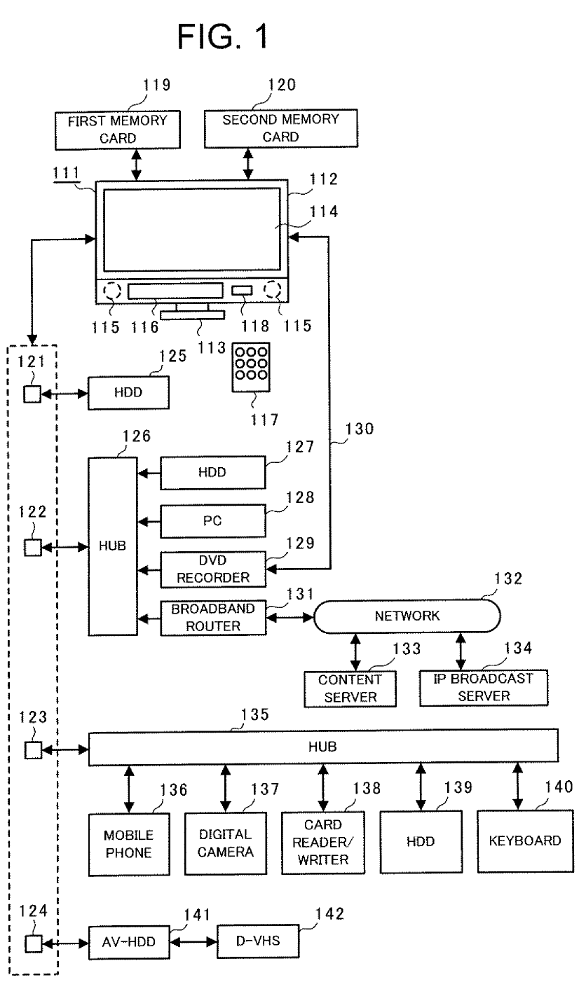

FIG. 1 schematically shows an appearance of a digital television broadcast receiving apparatus 111 of one embodiment to which the present invention is applied, and an example of a network system structured with this digital television broadcast receiving apparatus 111 being the center.

Specifically, the digital television broadcast receiving apparatus 111 is mainly constituted of a thin cabinet 112, and a support table 113 supporting the cabinet 112 standing upright.

Then in the cabinet 112, there are disposed, for example, an SED (Surface-conduction Electron-emitter Display) display panel, a flat-panel video display device 114 constituted of a liquid display panel or the like, speakers 115, an operating part 116, a light receiving part 118 receiving operation information transmitted from a remote controller 117, and son on.

Further, a first memory card 119 such as an SD (Secure Digital) memory card, an MMC (Multimedia Card) and a memory stick for example can be inserted in/removed from this digital television broadcast receiving apparatus 111.

This digital television broadcast receiving apparatus 111 is adapted to perform recording/reproducing of information such as a program or a picture with the first memory card 119.

Further, a second memory card (IC card) 120 in which contract information or the like for example is recorded can be inserted in/removed from this digital television broadcast receiving apparatus 111.

This digital television broadcast receiving apparatus 111 is adapted to perform recording/reproducing of information with the second memory card 120.

Further, this digital television broadcast receiving apparatus 111 has a first LAN (Local Area Network) terminal 121, a second LAN terminal 122, a USB (Universal Serial Bus) terminal 123 and an i.LINK terminal 124.

Among them, the first LAN terminal 121 is used as a dedicated port for a hard disk drive device (hereinafter referred to as “HDD”) corresponding to LAN, and is used for performing recording/reproducing of information with an HDD 125 corresponding to LAN, which is a connected NAS (Network Attached Storage) , by means of Ethernet (registered trademark).

Thus, by providing the first LAN terminal 121 as the LAN corresponding HDD dedicated port, information recording in the HDD 125 of a program by high-definition television image quality can be performed stably without being affected by other network environments, network use status, or the like.

Further, the second LAN terminal 122 is used as a general LAN corresponding port using Ethernet (registered trademark).

The second LAN terminal 122 is used for connecting, via a hub 126 for example, devices such as an HDD 127 corresponding to LAN, a computer (PC) 128, a DVD (Digital Versatile Disk) recorder 129 including an HDD, and the like and for performing transmission of information with these devices.

In addition, the PC 128 has a function to operate as a server device of contents in a home network.

The PC 128 is structured as a device corresponding to UPnP (universal plug-and-play) having a service of providing URI (Uniform Resource Identifier) information necessary for accessing a content.

In addition, since digital information communicated via the second LAN terminal 122 is only control-related information, the DVD recorder 129 needs to be provided with a dedicated analog transmission path 130 for transmitting analog video and audio information to/from the digital television broadcast receiving apparatus 111.

Furthermore, the second LAN terminal 122 is connected to a network 132 such as the Internet for example via a broadband router 131 connected to the hub 126.

This second LAN terminal 122 is used for performing transmission of information to/from a content server 133, an IP broadcast server 134, or the like via the network 132.

The content server 133 has a CPU, a memory, an HDD, and so on.

The content server 133 has a function to operate as a server device performing streaming distribution of a moving image that is started to be distributed on demand, such as a moving image content of video on demand (hereinafter referred to as “VOD”) for example.

This is a function to distribute a moving image content in an HDD in response to the request from a client.

The CPU of the content server 133 receives stop position information of a moving image content, whose reproduction is stopped during distribution for example, from the client and stores the information in the memory.

Then, when there is a request from the client for distribution of the moving image whose reproduction is paused, the CPU reads the moving image content from the stop position from the HDD according to the stop position information in the memory and performs streaming distribution of the content to the requester.

Further, the content server 133 is structured as a UPnP corresponding device having a service function to provide a client with URI information needed for accessing a moving image content.

To a client that has established a session via IP networks such as the Internet, the IP broadcast server 134 broadcasts a moving image content of an IP broadcast program or the like stored in the HDD in real time according to a program table.

The aforementioned USB terminal 123 is used as a general USB corresponding port, and is used for connecting, via a hub 135 for example, a USB device such as a mobile phone 136, a digital camera 137, a card reader/writer 138 for memory cards, an HDD 139, a keyboard 140, and the like and for performing transmission of information with these USB devices.

Further, the aforementioned i.LINK terminal 124 is used for serially connecting an AV-HDD 141, a D (Digital)-VHS (Video Home System) 142, or the like for example and performing transmission of information with these devices.

The above structure is merely an example, and instead of the cabinet integrated type, the digital television broadcast receiving apparatus 111 may be in a form of set-top box (video recorder of HDD included type or the like) for example to which the flat panel type video display device 114 is connected externally.

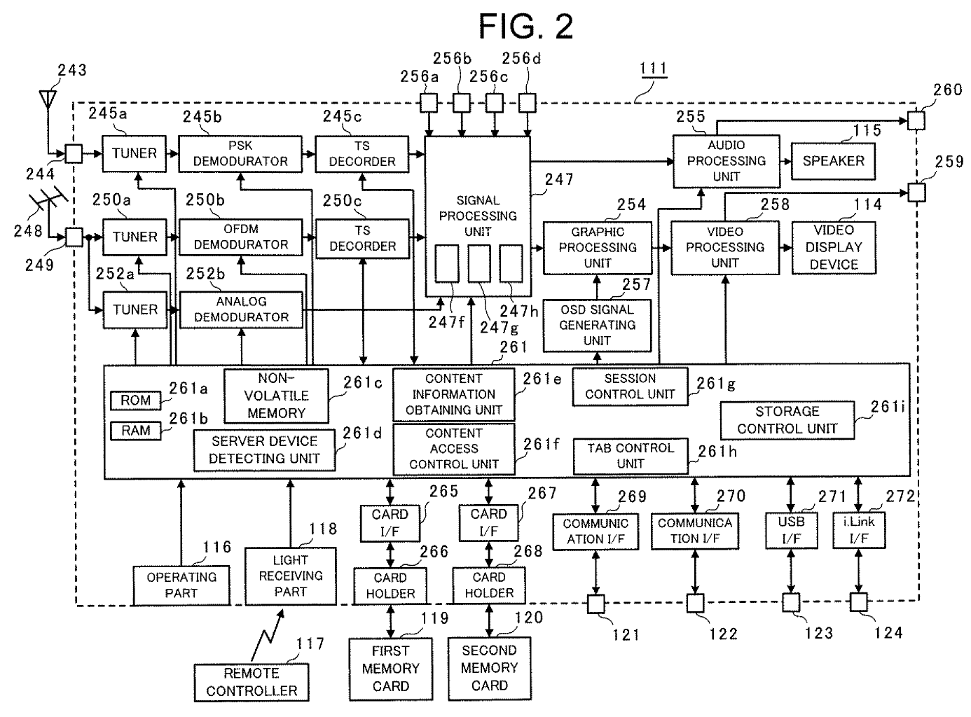

FIG. 2 shows a main signal processing system of the above-described digital television broadcast receiving apparatus 111.

As shown in the diagram, a satellite digital television broadcast signal, received by an antenna 243 for receiving a BS/CS digital broadcast, is supplied to a tuner 245a for satellite digital broadcasting via an input terminal 244.

The tuner 245a selects the broadcast signal of a desired channel by a control signal from a control unit 261, and outputs this selected broadcast signal to a PSK (Phase Shift Keying) demodulator 245b.

The PSK demodulator 245b demodulates the broadcast signal selected by the tuner 245a by a control signal from the control unit 261, obtains a transport stream including a desired program, and outputs the stream to a TS decoder 245c.

The TS decoder 245c performs, by the control signal from the control unit 261, TS decoding processing of a transport stream (TS) multiplexed signal, and outputs a PES (Packetized Elementary Stream) obtained by depacketizing a digital video signal and a digital audio signal of a desired program to an STD buffer in a signal processing unit 247.

Further, the TS decoder 245c outputs section information being sent by digital broadcasting to a section processing unit in the signal processing unit 247.

Further, a terrestrial digital television broadcast signal, received by an antenna 248 for receiving a terrestrial broadcast, is supplied to a tuner 250a for terrestrial digital broadcasting via an input terminal 249.

The tuner 250a selects a broadcast signal of a desired channel by a control signal from the control unit 261, and outputs this selected broadcast signal to an OFDM (Orthogonal Frequency Division Multiplexing) demodulator 250b.

The OFDM demodulator 250b demodulates the broadcast signal selected by the tuner 250a by a control signal from the control unit 261, obtains a transport stream including a desired program, and outputs the stream to a TS decoder 250c.

The TS decoder 250c performs, by a control signal from the control unit 261, TS decoding processing of a transport stream (TS) multiplexed signal.

Then the TS decoder 250c obtains a PES (Packetized Elementary Stream) by depacketizing a digital video signal and a digital audio signal of a desired program, and outputs the obtained PES (Packetized Elementary Stream) to the STD buffer 247f in the signal processing unit 247.

Further, the TS decoder 250c outputs section information transmitted by digital broadcasting to the section processing unit 247h in the signal processing unit 247.

Here, the signal processing unit 247 selectively performs predetermined digital signal processing on digital video signals and audio signals supplied respectively from the TS decoder 245c and the TS decoder 250c while the television is viewed.

Then the signal processing unit 247 outputs the video signals and audio signals subjected to the digital signal processing to a graphic processing unit 254 and an audio processing unit 255.

Further, while reproducing a content, the signal processing unit 247 selects a reproduction signal of a content inputted from the control unit 261, performs predetermined digital signal processing thereon, and outputs the signals to the graphic processing unit 254 and the audio processing unit 255.

To the control unit 261, there are inputted from the signal processing unit 247 various data and electric program guide (EPG) information for obtaining a program, program attribute information (program genre or the like), subtitle information and/or the like (service information, SI or PSI).

From these inputted information, the control unit 261 performs image generation processing for displaying EPG and/or subtitles, and outputs the generated image information to the graphic processing unit 254.

Among the section information inputted from the TS decoder 245c (250c), the section processing unit 247h of the signal processing unit 247 outputs to the control unit 261 various data and electric program guide (EPG) information for obtaining a program, program attribute information (program genre or the like), subtitle information and/or the like (service information, SI or PSI).

The graphic processing unit 254 has a function to combine (1) a digital video signal supplied from an AV decoder 247g in the signal processing unit 247, (2) an OSD signal generated in an OSD (On Screen Display) signal generating unit 257, (3) image data by data broadcasting, (4) EPG generated by the control unit 261, and a subtitle signal, and output the combined signal to a video processing unit 258.

Further, when displaying subtitles by subtitle broadcasting, the graphic processing unit 254 performs processing of superimposing subtitle information on a video signal based on subtitle information by control from the control unit 261.

The digital video signal outputted from the graphic processing unit 254 is supplied to the video processing unit 258.

After converting the inputted digital video signal into an analog video signal in a format that can be displayed by the video display device 114, the video processing unit 258 outputs the signal to the video display device 114 for displaying the video, and further directs the signal to the outside via an output terminal 259.

Further, after converting the inputted digital audio signal into an analog audio signal in a format that can be reproduced by the speakers 115, the audio processing unit 255 outputs the signal to the speakers 115 for reproducing the audio, and further directs the signal to the outside via an output terminal 260.

Here, in this digital television broadcast receiving apparatus 111, all operations including the above-described various types of receiving operations are controlled in an integrated manner by the control unit 261.

This control unit 261 includes a CPU (Central Processing unit) and so on and receives operation information from the aforementioned operating part 116.

Further, the control unit 261 receives operation information transmitted from the remote controller 117 via the light receiving part 118, and controls the related units so as to reflect the contents of operation thereof.

In this case, the control unit 261 uses mainly a ROM (Read Only Memory) 261a storing a control program executed by the CPU, a RAM (Random Access Memory) 261b providing a work area to the CPU, and a non-volatile memory 261c storing various setting information, control information, or the like.

Further, this control unit 261 is connected via a card I/F (Interface) 265 to a card holder 266 in which the first memory card 119 can be fitted.

Accordingly, the control unit 261 can transmit information to the first memory card 119 fitted in the card holder 266 via the card I/F 265.

Furthermore, the control unit 261 is connected via a card I/F 267 to a card holder 268 in which the second memory card 120 can be fitted.

Accordingly, the control unit 261 can transmit information to the second memory card 120 fitted in the card holder 268 via the card I/F 267.

Further, the control unit 261 is connected to the first LAN terminal 121 via a communication I/F 269.

Accordingly, the control unit 261 can transmit information to the HDD 125 corresponding to LAN connected to the first LAN terminal 121 via the communication I/F 269.

In this case, the control unit 261 has a DHCP (Dynamic Host Configuration Protocol) server unit, and assigns an IP (Internet Protocol) address on the HDD 125 corresponding to LAN connected to the first LAN terminal 121 to control this HDD.

Furthermore, the control unit 261 is connected to the second LAN terminal 122 via a communication I/F 270.

Accordingly, the control unit 261 can transmit information to the devices (refer to FIG. 1) connected to the second LAN terminal 122 via the communication I/F 270.

Further, the control unit 261 is connected to the USB terminal 123 via a USB I/F 271. Accordingly, the control unit 261 can transmit information to the devices (refer to FIG. 1) connected to the USB terminal 123 via the USB I/F 271.

Furthermore, the control unit 261 is connected to the i.LINK terminal 124 via an i.LINK I/F 272. The “i.LINK” is a registered trademark.

Accordingly, the control unit 261 can transmit information to the devices (refer to FIG. 1) connected to the i.LINK terminal 124 via the i.LINK I/F 272.

The HDD 125 stores and retains a register file describing storage IDs (including IP addresses, device names) which are assigned respectively to the HDD 125, HDD 127, and DVD recorder 129.

The control unit 261 includes a server device detecting unit 261d using UPnP, a content information obtaining unit 261e using UPnP, a content access control unit 261f, a session control unit 261g, a tab control unit 261h, and a storage control unit 261i.

In addition, the content access control unit 261f, the session control unit 261g, the tab control unit 261h, the storage control unit 261i, and so on function as a tab browser.

The control unit 261 detects a UPnP corresponding device on the network using the discovery function of UPnP by the server device detecting unit 261d.

For example, the server device detecting unit 261d detects (finds) the content server 128 using the discovery function of UPnP.

The control unit 261 controls the UPnP corresponding device using the control function of UPNP by the content information obtaining unit 261e, and obtains URI information necessary for accessing a content in the UPnP corresponding device.

For example, the content information obtaining unit 261e controls the content server 128 and obtains from the content server 128 URI information necessary for accessing a content stored in the HDD or the like in the content server 128.

Based on IP address information of a server device obtained by the server device detecting unit 261d, IP address information obtained from URI information obtained by the content information obtaining unit 261e, and the IP address and the net mask assigned to this digital television broadcast receiving apparatus 111, the control unit 261 accesses a content in this server device by the content access control unit 261f.

When the moving image being reproduced is paused by switching of a tab, the content access control unit 261f notifies the content server 133 of information(time stamp) of the stopped position stored in the RAM 261b or the non-volatile memory 261c.

The session control unit 261g establishes a session with the content server 133 and/or the IP broadcast server 134 as necessary when a moving image is reproduced.

The tab control unit 261h switches the corresponding moving image reproducing unit to activate or inactivate along with an operation of a tab, and generates a command indicating the switching of the tab (hereinafter referred to as “switching command”).

The moving image reproducing unit is constituted of the graphic processing unit 254, moving image reproducing application software (software read into a memory and started), and the like. The moving image reproducing unit reproduces a moving image on a screen opened by a tab operation.

The tab control unit 261h starts the moving image reproducing unit (including a screen and a moving image reproducing application) for each tab.

Tabs are provided corresponding to moving image reproducing units respectively, and function as a plurality of buttons for selecting and operating a desired moving image reproducing unit.

When any one of the moving image reproducing units being started is activated, the moving image reproducing unit reproduces on its screen a moving image (first moving image) distributed by streaming from the network in response to a request or a moving image (second moving image) that is provided by receiving broadcast. In other words these moving images are different moving images of the distribution form.

Specifically, the moving image reproducing unit reproduces a moving image when activated and stops reproduction of the moving image when inactivated.

On the screen, only the screen of an active moving image reproducing unit is displayed.

The tab control unit 261h generates a switching command when an operation of generating a tab is newly performed.

Further, when one of tab #1 13, tab #2 14 and so on already displayed on the screen, for example the tab #2 14 is clicked (selected), the tab control unit 261h activates the corresponding moving image reproducing unit and displays a screen 21 on the video display device 114.

The tab control unit 261h inactivates a screen 11 of a currently active tab #1, and switches the screen 21 of the clicked inactive tab #2 14 to be activated to activate.

Specifically, the tab control unit 261h functions as a switching control unit which activates the moving image reproducing unit corresponding to a selected tab, and switches the moving image reproducing unit corresponding to a non-operated tab to inactive. The tab control unit 261h generates a switching command along with switching of the tab.

The storage control unit 261i detects generation of the switching command and performs a control operation to restart moving image reproduction operation according to the type of a moving image whose reproduction is stopped.

Specifically, when the moving image whose reproduction is stopped is an IP broadcast program, the storage control unit 261i starts recording of the IP broadcast program being received.

Further, when the moving image whose reproduction is stopped is a VOD moving image, the storage control unit 261i stores the stop position information at the time of pausing in the RAM 261b or the non-volatile memory 261c.

Specifically, the storage control unit 261i stops the moving image reproduction operation of a screen 13 of a tab #1 inactivated by the tab control unit 261h, and stores the stop position information at that moment in the RAM 261b or the non-volatile memory 261c.

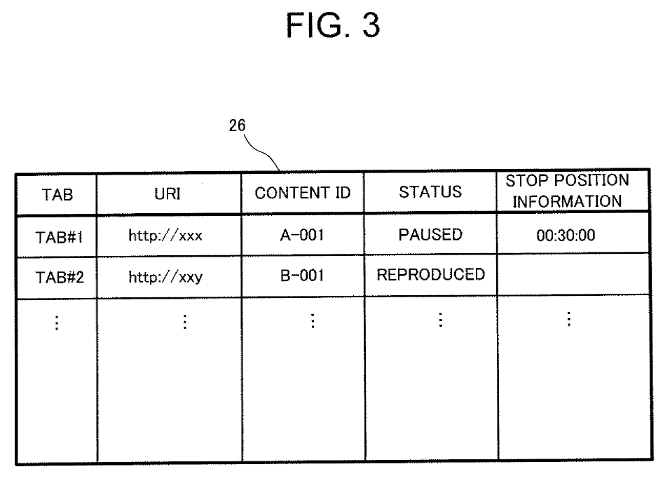

In this example, it is assumed that the stop position information is stored in a tab management table 26 (refer to FIG. 3) of the non-volatile memory 261c.

As shown in FIG. 3, in the tab management table 26 of the non-volatile memory 261c, every time a tab is created, a storage area (one row of records) is generated for managing the tab.

In the storage area of each tab, there are stored the location (URI, URL, or the like) of a content displayed on the screen of each tab, the content ID being reproduced, the status of the content, and the stop position information when the content is a moving image content and reproduction thereof is paused.

For example, when a tab is switched when 30 minutes has elapsed from the start of reproduction of a moving image and the reproduction of the moving image is paused, the elapsed time (time, minute, second “00:30:00” or the like)from the start of reproduction is stored as stop position information.

The non-volatile memory 261c functions as a memory capable of storing information of the position where reproduction of a moving image is stopped for each moving image reproducing unit.

The storage control unit 261i stores information of a position where a moving image reproducing unit switched from active to inactive stopped reproduction of a moving image in the tab management table 26 of the non-volatile memory 261c.

When a moving image reproducing unit that is inactivated once is activated again by operation of a button, the storage control unit 261i functions as a reproduction control unit which restarts reproduction of a moving image from information of stopped position notified to the content server 133 or a recording start position of a moving image being recorded.

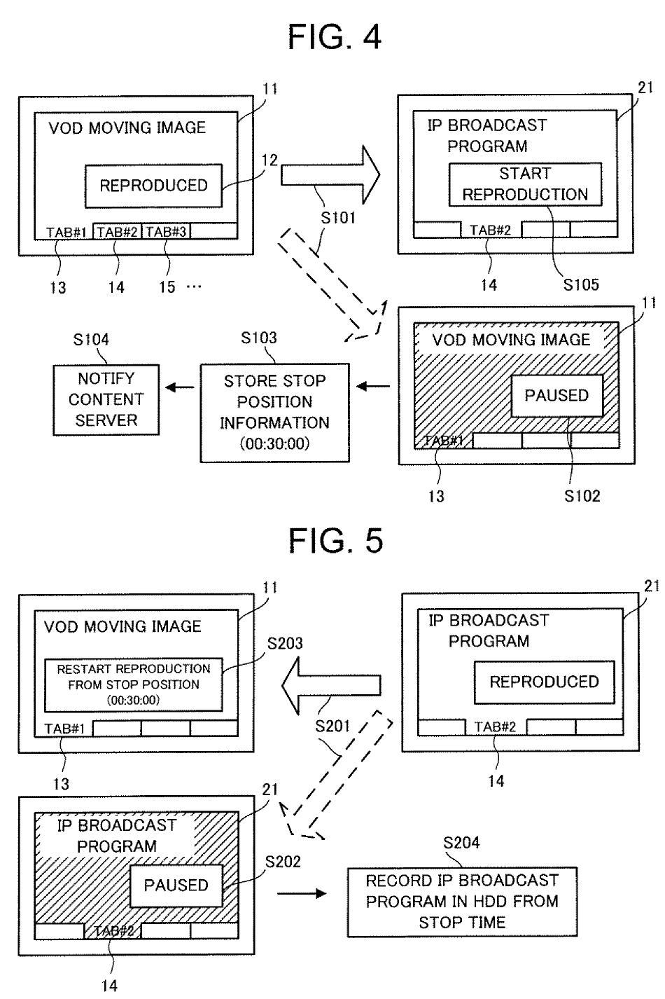

Hereinafter, with reference to FIG. 4 and FIG. 5, an operation of this digital television broadcast receiving apparatus will be explained.

As shown in FIG. 4, the case where, for example, the user clicks the tab #2 14 and switches the screen while a VOD moving image is reproduced in the screen 11 of the tab #1 13 will be explained.

Note that at this time, it is assumed that no moving image is reproduced in the screen 21 of the tab #2 14. (Switching of the tab #1 13→tab #2 14)

While the VOD moving image is reproduced in the screen 11 of the tab #1 13, when the user clicks the tab #2 14 the tab control unit 261h switches the screen 11 of the tab #1 13 to inactive and switches the screen 21 of the tab #2 14 to active (step S101 in FIG. 4).

Further, the tab control unit 261h generates a command (switching command) indicating switching of the screen 11 of the tab #1 13 to the screen 21 of the tab #2 14.

When this switching command is detected by the storage control unit 261i, the storage control unit 261i pauses the VOD moving image being reproduced (step S102), and stores the stop position information thereof (information such as how many hours and minutes have elapsed from the start of reproduction) in the field of the corresponding tab in the tab management table 26 (step S103).

Here, in the control unit 261, the content access control unit 261f refers to the updated tab management table 26 and determines the type of the moving image from the content ID of the moving image whose reproduction is stopped.

For example, when the head of the content ID is “A”, the content access control unit 261f determines that it is a moving image whose reproduction is started according to a request, namely, a VOD moving image.

Further, when the head of the content ID is “B”, the content access control unit 261f determines that it is a moving image for which a real-time characteristic is required, an IP broadcast program as in this example.

As a result of this determination, when the type of the moving image is a VOD moving image as in this example, information of the stop position stored in the tab management table 26 is notified to the content server 133 (step S104).

Subsequently, on the screen 21 of the switched tab #2 14, when the user performs an operation (such as specifying the URI of a program) for viewing a desired digital broadcast program broadcasted via the network 132 (IP network) for example, the session control unit 261g establishes a session with the corresponding IP broadcast server 134 and receives the broadcast of the IP broadcast server 134.

Accordingly, the received IP broadcast program is run on the screen 21 of the tab #2 14, that is, the moving image is reproduced (step S105).

Note that when the result of the above-described determination of moving image type is an IP broadcast program for example, the storage control unit 261i starts recording in the HDD 125 from the point of time when the tab #1 13 is inactivated. (Switching of the tab #2 14→the tab #1 13).

Thereafter, while the IP broadcast program is reproduced (viewed) on the screen 21 of the tab #2 14 or after it is finished, when the user desires to view the previously viewed VOD moving image and clicks the screen 11 of the tab #1 13 in an inactive state, the tab control unit 261h switches the screen 11 of the tab #1 13 to activate and on the other hand switches the screen 21 of the tab #2 14 to inactivate (step S201 of FIG. 5), and pauses receiving of the IP broadcast program being reproduced (step S202).

Further, the tab control unit 261h generates a switching command from the screen 21 of the tab #2 14 to the screen 11 of the tab #1 13.

When this switching command is detected by the content access control unit 261f, the content access control unit 261f accesses the content server 133, and requests for streaming distribution of the paused VOD moving image from the stop position thereof.

The CPU of the content server 133 distributes the VOD moving image by streaming to the requester from the stop position stored in the memory according to this moving image distribution request.

Accordingly, on the screen 11 of the tab #1 13 of this digital television broadcast receiving apparatus 111, the reproduction of the moving image is restarted from the position (00:30:00) where it is paused previously (step S203).

On the other hand, the storage control unit 261i refers to the tab management table 26 and determines by the content ID the type of the moving image on the screen 21 of the tab #2 14 switched to inactivate.

As a result of this determination, when the type of the moving image on the screen 21 of the tab #2 14 is an IP broadcast program, the storage control unit 261i records in the HDD 125 the IP broadcast program being received from that point of time (step S204).

Thereafter, when the tab #2 14 is clicked, the storage control unit 261i reads and reproduces the IP broadcast program from the recording start time from the HDD 125, and meanwhile continues the recording of the currently received program in the HDD 125 until this program finishes. That is a so-called “follow-up reproduction or time shift playback”.

Thus, according to the digital television broadcast receiving apparatus of this embodiment, by mounting the tab browser function corresponding to viewing, browsing of a VOD moving image distributed by streaming from the network and an IP broadcast program, making the reproducing screens of moving images as tabs, and switching and displaying one screen selected by operating a tab, two moving images can be reproduced with the use of resources being suppressed to low.

Further, in a state that moving images are loaded simultaneously to the screens 11, 21 of the plurality of tabs #1 13, #2 14, for a moving image loaded to another tab turned to inactive when a moving image is viewed on a screen opened by selecting one tab, storing and notifying a stop position or recording a program thereafter enables to restart reproduction of the moving image at the time of switching the screen when it is returned to the original screen by operating the tab. Thus, the moving image after the pause can be viewed without missing.

It should be noted that the present invention is not limited only to the above-described embodiments. In the stage of implementation, the components can be modified within the range not departing from the spirit of the invention.

Further, various kinds of inventions can be made by appropriately combining a plurality of components disclosed in the above-described embodiments.

For example, several components may be deleted from all the components shown in the embodiments. Furthermore, components in different embodiments may be combined as appropriate.

Specifically, in the above-described embodiments, there is explained the case where the user clicks the tab #2 14 and switches to a screen where nothing is loaded while a VOD moving image is reproduced on the screen 11 of the tab #1 13, it may be a state that different types of moving images or the same type of moving images are loaded simultaneously to the screens 11, 21 of the plurality of tabs #1 13, #2 14.

Further, in this embodiment, the explanation is given with, as the types of moving images, a combination of a VOD moving image distributed by streaming via a wired network and an IP broadcast program, but beside that, a program of digital broadcast or analog broadcast that is broadcasted via radio waves may be combined with a VOD moving image distributed by streaming via a wired network and an IP broadcast program.

### OTHER EMBODIMENTS

Embodiments of the present invention are not limited to the above-described embodiments but can be expanded and/or modified, and expanded or modified embodiments are also included in the technical scope of the present invention.

What is claimed is:

1. A moving image reproducing apparatus, comprising:
a plurality of moving image reproducing units reproducing a moving image when activated and stopping reproduction of a moving image when inactivated;
a storage unit capable of storing information of a position when reproduction of the moving image is stopped for each of said moving image reproducing units;
a switching control unit activating, when an operation to activate any one of said plurality of moving image reproducing units is performed, a corresponding one of said moving image reproducing units and switching the other moving image reproducing units to inactive;
a storage control unit storing in said storage unit, information of a position where said moving image reproducing unit switched by said switching control unit from active to inactive, stopped reproduction of a moving image; and
a reproduction control unit reading information of a stop position from said storage unit when an operation of reactivation is performed on one of said moving image reproducing units that is inactivated once, and restarting reproduction of the moving image according to the read information of the stop position.

2. The moving image reproducing apparatus according to claim 1,
wherein moving images reproduced respectively by said plurality of moving image reproducing units are a first moving image distributed by streaming via a network and a second moving image broadcasted in real time via the network, and
further comprising a notification unit notifying, when reproduction of the first moving image is stopped by an inactivated one of said moving image reproducing units, information of a stop position to the distribution source of the first moving image.

3. The moving image reproducing apparatus according to claim 1,
wherein moving images reproduced respectively by said plurality of moving image reproducing units are a first moving image distributed by streaming via a network and a second moving image broadcasted in real time via the network, and
further comprising a recording unit recording, when reproduction of the second moving image is stopped by an inactivated one of said moving image reproducing units, the second moving image from this point of time.

4. The moving image reproducing apparatus according to claim 1,
further comprising a display device displaying a moving image reproduced by said moving image reproducing units.

5. The moving image reproducing apparatus according to claim 2,
further comprising a display device displaying a moving image reproduced by said moving image reproducing units.

6. The moving image reproducing apparatus according to claim 3,
further comprising a display device displaying a moving image reproduced by said moving image reproducing units.

7. A moving image reproducing method for a moving image reproducing apparatus comprising a plurality of moving image reproducing units reproducing a moving image when activated and stopping reproduction of a moving image when inactivated, the method comprising:
activating, when an operation to activate any one of the plurality of moving image reproducing units is performed, a corresponding one of the moving image reproducing units and switching the other moving image reproducing units to inactive;
storing in a storage unit information of a position where the moving image reproducing unit switched from active to inactive stopped reproduction of a moving image; and
restarting, when an operation of reactivation is performed on one of the moving image reproducing units that is inactivated once, reproduction of the moving image according to information of the stop position read from the storage unit.

8. The moving image reproducing method according to claim 7,
wherein moving images reproduced respectively by the plurality of moving image reproducing units are a first moving image distributed by streaming via a network and a second moving image broadcasted in real time via the network, and
further comprising notifying, when reproduction of the first moving image is stopped by an inactivated one of the moving image reproducing units, information of a stop position to the distribution source of the first moving image.

9. The moving image reproducing method according to claim 7,
wherein moving images reproduced respectively by the plurality of moving image reproducing units are a first moving image distributed by streaming via a network and a second moving image broadcasted in real time via the network, and
further comprising recording, when reproduction of the second moving image is stopped by an inactivated one of the moving image reproducing units, the second moving image from this point of time.

10. The moving image reproducing method according to claim 7,
further comprising displaying on a display device a moving image reproduced by the moving image reproducing units.

11. The moving image reproducing method according to claim 8,
further comprising displaying on a display device a moving image reproduced by the moving image reproducing units.

12. The moving image reproducing method according to claim 9,
further comprising displaying on a display device a moving image reproduced by the moving image reproducing units.
